(19) United States
(12) Patent Application Publication
(10) Pub. No.: US 2008/0127563 A1
(43) Pub. Date: Jun. 5, 2008

(54) REAR SLIDER WINDOW ASSEMBLY

(75) Inventor: Troy F. Tooker, Allegan, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DONNELLY CORPORATION, Holland, MI (US)

(21) Appl. No.: 11/948,094

(22) Filed: Nov. 30, 2007

Related U.S. Application Data
(60) Provisional application No. 60/872,256, filed on Dec. 1, 2006.

(51) Int. Cl. E05F 15/06; B23P 11/00

(52) U.S. Cl. 49/349; 29/428

(57) ABSTRACT

A rear slider window assembly for a vehicle and method of installing a rear slider window assembly at a vehicle includes providing a window module having a movable window panel that is movable along at least one guide rail, a drive mechanism that is operable to move the movable window panel, and a drive motor assembly that is selectively actuatable to rotatably drive the drive mechanism to move the movable window panel along the at least one guide rail. The drive motor assembly is connected to the drive mechanism via a snap connection and without any separate fasteners.

### CROSS REFERENCE TO RELATED APPLICATION

The present application claims benefit of U.S. provisional application Ser. No. 60/872,256, filed Dec. 1, 2006, which is hereby incorporated herein by reference in its entirety.

### FIELD OF THE INVENTION

The present invention relates to a rear slider window assembly for a vehicle and, more particularly, a powered rear slider window assembly for a vehicle.

### BACKGROUND OF THE INVENTION

It is known to provide a slider window assembly for a rear opening of a pick up truck. Conventional slider window assemblies for rear openings of trucks or the like typically include three or more panels, such as two fixed window panels and at least one slidable window panel. The fixed window panels are supported in a spaced relationship, for example, by a support, such as a frame. The slidable window panel (or panels) is/are supported by rails, which are typically mounted to the support. The slider window panel may be moved along the rails via a powered slider mechanism.

The trend in vehicle windows is to form a pre-assembled modular assembly that can be installed to the vehicle as a single component. As a result, the window assembly comprises a pre-assembled unit that is easier to handle during shipping and installation. Examples of such pre-assembled units are shown in U.S. Pat. Nos. 4,606,159; 4,723,809; 5,853,895; 6,086,138; and 6,293,609, which are incorporated by reference herein in their entireties. However, such modular assemblies often have the drive motor and slider mechanism assembled together and supported at the window assembly, such as at the window opening. Such assemblies, with the motor and slider mechanism at the window opening, take up an increased amount of space in the shipping containers, and thus, fewer window assemblies may be shipped in a single container. Further, when installing the window assemblies in the vehicle and moving the motor to its installed position, the motor may contact the window module adhesive or may be otherwise marred or damaged, leading to an increase in scrapping of the motors and/or window assemblies.

It has been proposed to provide a window assembly that includes the slider mechanism, but with the motor detached therefrom, whereby the slider mechanism may be attached to the motor at the vehicle assembly facility or plant. For example, and as shown in FIGS. 1-4, a prior art window assembly 10 includes a window module 12 and a slider drive mechanism 14, which is attached to a powered drive motor 16 when the system is installed and operated in the vehicle but that is, advantageously, detachable from the powered drive motor 16 for ease of shipment to the vehicle assembly plant and/or service should a component or part of the installed system malfunction or break. The slider mechanism 14 includes a gear box or drive portion 14a and cables 14b that cause the slider window 12a to slide or move along rails 12b between an opened position and a closed position, as is known in the art. The motor 16 is mounted to a motor bracket 18, which is mounted to the vehicle at the vehicle assembly plant. The window assembly may be provided to the assembly plant without the drive motor 16, whereby the slider mechanism 14 may attach to the drive motor 16 and motor bracket 18 at the vehicle assembly plant.

As shown in FIG. 4, the motor 16 includes a drive portion 16a that protrudes through an opening 18c in bracket 18 for engaging the drive mechanism 14. The drive portion 14a of drive mechanism 14 includes a tab 14c that is received in a slot 18a of bracket 18 as the components are assembled together, whereby the drive portion may be pivoted or rotated relative to bracket 18 until tab 14c engages a stop surface 18b of the slot 18a to generally align the drive mechanism. The drive mechanism 14 is secured to the bracket via a threaded male fastener or screw or bolt that is inserted through a hole 14d in drive portion 14a that is threaded into a threaded female fastener 18d at bracket 18.

Although such an assembly allows for shipping the window assemblies without the motors attached thereto, it adds an assembly process at the vehicle assembly plant. More particularly, such an assembly and system requires an operator at the assembly plant to attach the drive mechanism to the motor and motor bracket and then to align and drive a fastener through the drive mechanism and into the bracket to secure the components together. Such an operation not only takes additional time for the operator to complete, but requires an additional component (a threaded fastener) at the vehicle assembly plan and requires the use of a drive tool at the operator's station.

Therefore, there is a need in the art for an improved powered rear slider window assembly and method of installation that overcomes the shortcomings of the prior art.

### SUMMARY OF THE INVENTION

The present invention provides a rear slider window assembly that provides for shipping a window module and slider drive mechanism separate from the drive motor and drive motor assembly and mounting bracket, whereby the slider drive mechanism may be connected to or snapped to the drive motor assembly at the vehicle assembly plant and via a snap connection and without the use of any threaded fasteners or tools. The present invention thus provides enhanced processing at the vehicle assembly plant and may reduce parts at the assembly plant and may reduce the need for a drive tool at that station at the vehicle assembly plant.

According to an aspect of the present invention, a method of installing a rear slider window assembly at a vehicle includes providing a window module to a vehicle assembly plant, providing a drive motor assembly to the vehicle assembly plant, and connecting the drive motor assembly to the drive mechanism at the vehicle assembly plant. The window module comprises a movable window panel that is movable along at least one guide rail, and comprises a slider drive mechanism for moving the movable window panel. The drive motor assembly is selectively actuatable to rotatably drive the drive mechanism when connected thereto to move the movable window panel along the at least one guide rail. The drive motor assembly is provided to the vehicle assembly plant as a separate, detached component that is separate and detached from the slider drive mechanism, and wherein connecting the drive motor assembly to the drive mechanism comprises connecting the drive motor assembly to the drive mechanism via a snap connection and without any separate fasteners, such as threaded fasteners or the like.

These and other objects, advantages, purposes and features of the present invention will become apparent upon review of the following specification in conjunction with the drawings.

### BRIEF DESCRIPTION OF THE DRAWINGS

FIG. 1 is a rear elevation of a prior art rear slider window assembly for a vehicle;

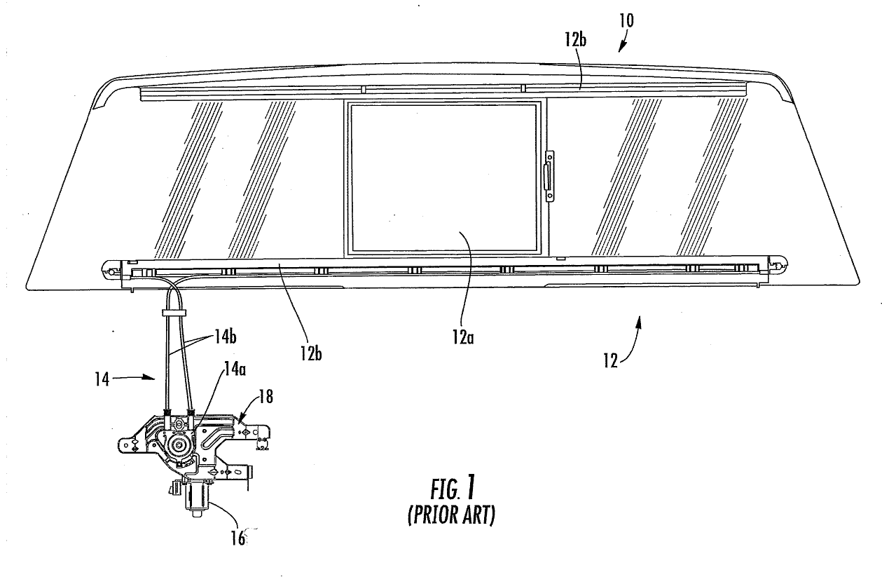

FIG. 2 is an enlarged view of the motor and slider control mechanism of the rear slider window assembly of FIG. 1;

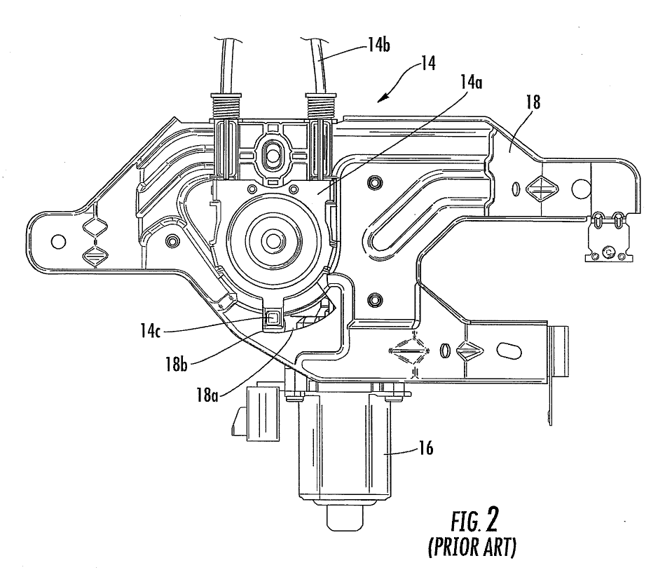

FIG. 3 is another perspective view of the prior art rear slider window assembly of FIG. 1, shown with the motor detached from the slider control mechanism;

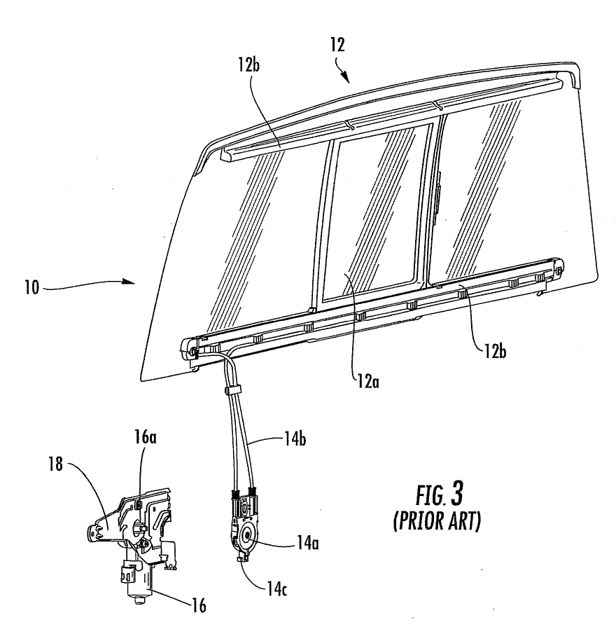

FIG. 4 is an enlarged view of the motor and slider control mechanism of FIG. 3;

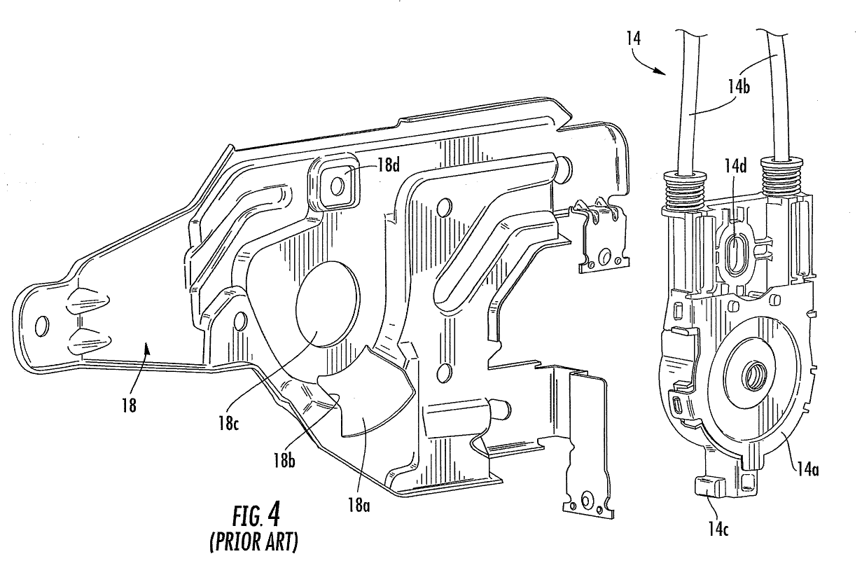

FIG. 5 is a rear elevation of a rear slider window assembly for a vehicle in accordance with the present invention;

FIG. 6 is an enlarged view of the motor and slider control mechanism of the rear slider window assembly of FIG. 5;

FIG. 7 is another perspective view of the rear slider window assembly of FIG. 1, shown with the motor detached from the slider control mechanism;

FIG. 8 is an enlarged perspective view of the motor and slider control mechanism of FIG. 7; and

FIG. 9 is an opposite perspective view of the motor and slider control mechanism of FIG. 8.

### DESCRIPTION OF THE PREFERRED EMBODIMENTS

Referring now to the drawings and the illustrative embodiments depicted therein, a rear slider window assembly 110 includes a window module 112 and a slider mechanism 114, which is attached to a powered drive motor assembly 116. The slider mechanism 114 includes a gear box or drive portion 114a and cables 114b that cause the slider window 112a to slide or move along an upper rail 112b and a lower rail 112c between an opened position and a closed position, such as in a similar manner as is known in the art. The drive motor assembly 116 is mounted to a motor bracket 118, which is mounted to the vehicle at the vehicle assembly plant, such as via fasteners or the like. The window assembly is provided to the assembly plant without the drive motor assembly 116 attached thereto, whereby the drive portion 114a of the slider mechanism 114 is attached to the drive motor assembly 116 and motor bracket 118 at the vehicle assembly plant without the use of any fasteners or tools, as discussed below.

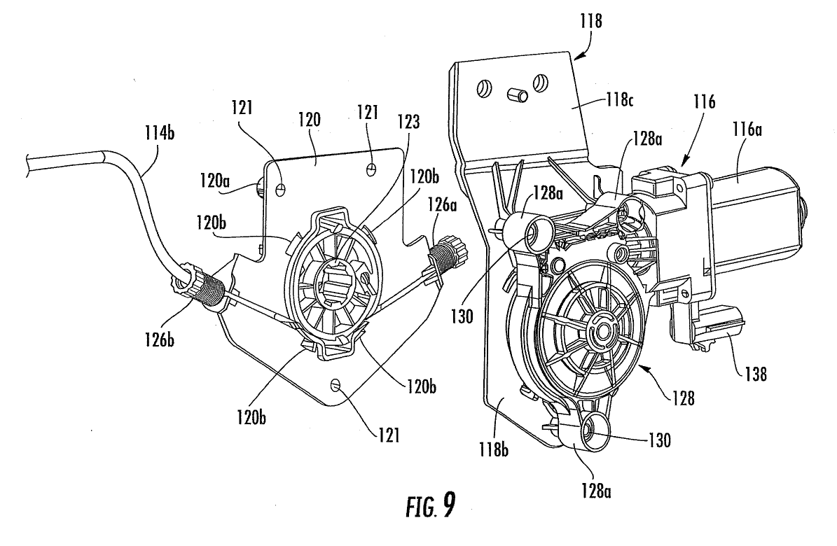

Window module 112 includes a pair of fixed window panels 112d that are spaced apart so as to define an opening therebetween. Slider window 112a is movable along rails 112b, 112c to open and close the opening, such as in a manner similar to known slider window assemblies. The movable slider window panel 112a is movable in response to actuation of a drive motor 116a of the drive motor assembly 116, which rotatably drives a spool 123 (FIG. 9) of drive portion 114a of slider mechanism 114 to move the cables 114b, which impart horizontal movement of the slider window 112a along the rails 112b, 112c. Optionally, the drive motor assembly may utilize aspects of the drive assemblies of the types described in U.S. Pat. Nos. 4,920,698; 4,995,195; 5,146,712; 5,531,046; 5,572,376; 6,119,401; and 6,955,009, and U.S. pat. applications, Ser. No. 10/454,040, filed Jun. 4, 2003 (Attorney Docket DON02 P-1095); and/or Ser. No. 10/697,372, filed Oct. 29, 2003 by Galer for HORIZONTAL SLIDER WINDOW ASSEMBLY, now U.S. Pat. No. 7,073,293, which are hereby incorporated herein by reference in their entireties.

Optionally, the window assembly or assemblies of the present invention may utilize aspects of the window assemblies described in U.S. Pat. Nos. 7,073,293; 7,003,916; and/or 6,691,464, and/or U.S. patent applications, Ser. No. 10/263,221, filed Oct. 31, 2005 by Nestell et al. for REAR SLIDER WINDOW ASSEMBLY FOR VEHICLE (Attorney Docket DON02 P-1223); Ser. No. 10/454,040, filed Jun. 4, 2003 by Galer et al. for SLIDER WINDOW ASSEMBLY (Attorney Docket DON02 P-1095); and/or Ser. No. 10/408,047, filed Apr. 4, 2003 by Galer for SLIDER WINDOW ASSEMBLY (Attorney Docket DON02 P-1083), which are hereby incorporated herein by reference in their entireties.

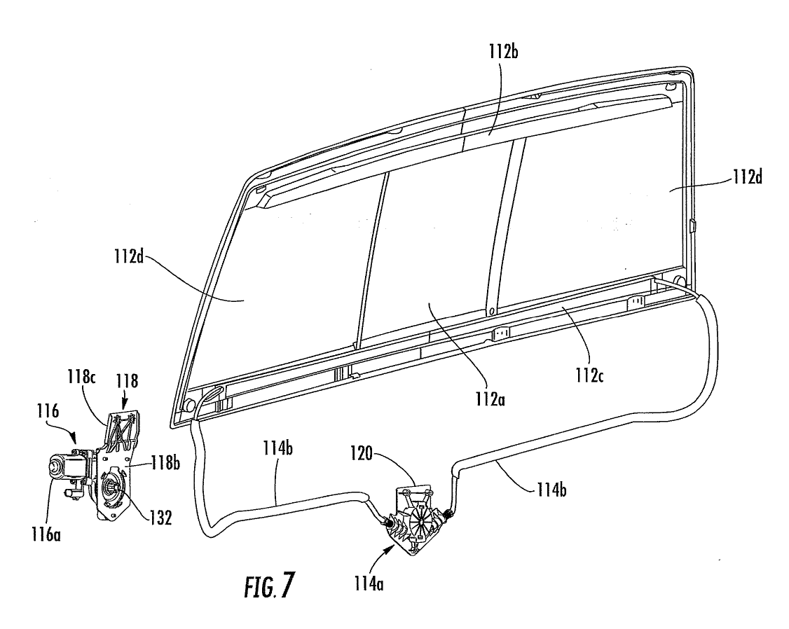

As shown in FIGS. 7-9, window module 112 and slider mechanism 114 may be provided to a vehicle assembly plant with the drive motor assembly 116 and motor bracket 118 detached therefrom. The cables 114b of slider mechanism 114 are connected between the drive portion 114a and respective movable elements that move along the lower rail 112c and that move the slider window panel 112a. The drive portion 114a may be moved or flipped upward so as to be located generally at the opening between the fixed window panels 112d (with the slider window panel 112a moved to its open position), where the drive portion 114a may be secured relative to the window module for shipping. After the window module and drive mechanism are shipped to the vehicle assembly plant, the drive portion 114a may be moved to the installation position and orientation as shown in FIG. 7 for installation of the window module to the vehicle.

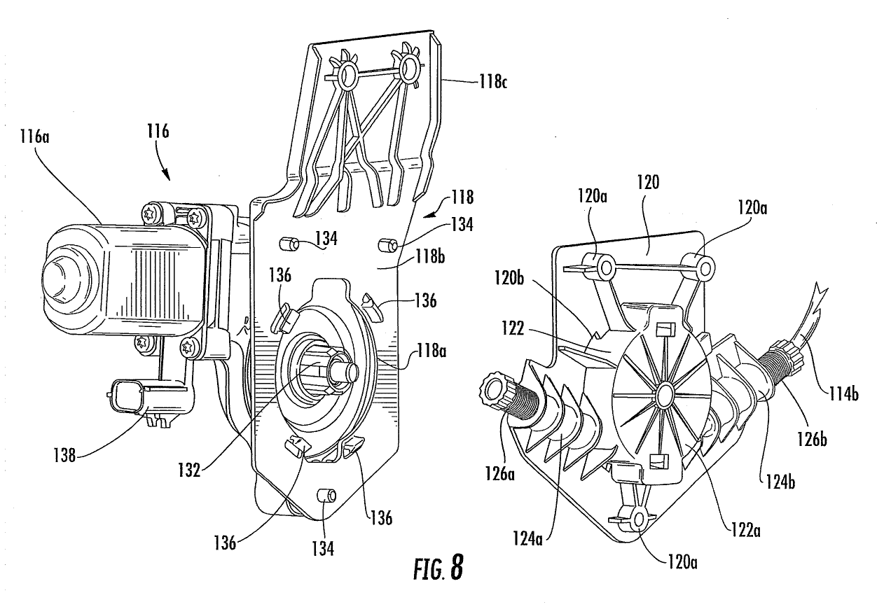

As best shown in FIGS. 8 and 9, drive portion 114a comprises a plastic or polymeric mounting plate 120 and a housing portion 122 for housing a spool 123 (FIG. 9) for moving the cables in either direction (via rotation of spool 123 in either direction in response to rotational driving by drive motor 116a) to move the slider window panel between its open and closed positions. Drive portion 114a further includes cable guides 124a, 124b for guiding the cables 114b at the mounting plate 120 and housing portion 122 (with the cables 114b having biasing elements or springs 126a, 126b at the guides 124a, 124b for providing the desired or appropriate tension in the cables). In the illustrated embodiment, mounting plate 120 further includes a plurality of bosses 120a for receiving guide elements of the drive motor assembly and/or bracket, as discussed below. Also, mounting plate 120 includes a plurality of slots 120b for receiving locking tabs or elements of the drive motor assembly and/or bracket, as also discussed below. Optionally, and desirably, the mounting plate and housing portion may be unitarily or integrally formed, such as via injection molding or the like. Optionally, the housing portion 122 may be closed by a separate cover element 122a (FIG. 8) that is attachable to the housing portion 122 to substantially close the housing portion and contain the spool 123 therein.

Drive motor assembly 116 includes drive motor 11 6a that is mounted to a mounting portion and gear box 128, which in turn is mounted to or attached to motor bracket 118. Mounting portion 128 includes a plurality of bosses 128a, which have passageways therethrough for receiving respective fasteners 130 therethrough for attaching drive motor assembly 116 to motor bracket 118. Drive motor assembly 116 includes a drive pinion or sprocket 132 that is located at or protrudes partially from an opening of mounting portion 128, and that is located at or protrudes partially from an opening 118a of motor bracket 118 (as shown in FIG. 8), for engaging spool 123 of drive portion 114a, as discussed below.

Motor bracket 118 comprises a generally flat or planar plate portion 118b through which opening or aperture 118a is formed, and a vehicle mounting portion 118c for mounting or attaching the bracket 118 to the vehicle. Plate portion 118b of motor bracket 118 also includes a plurality of bosses 134, which may have threaded passageways at least partially therethrough for receiving fasteners 130 of mounting portion 128 for securing the drive motor assembly 116 to bracket 118. Plate portion 118b of motor bracket 118 also includes a plurality of locking elements or tabs 136 that extend from plate portion 118b. In the illustrated embodiment, the tabs 136 comprise flexible tabs with a camming surface thereon, such that the tabs flex as they are inserted into slots 120b of mounting plate 120, and that snap in place when fully inserted into the slots to substantially secure the plate portion 118b to mounting plate 120, so as to provide a snap connection between the mounting plate and the plate portion without any fasteners, as discussed below. Preferably, motor bracket 118 comprises a molded bracket that is molded, such as via injection molding or the like, of a polymeric or plastic material. However, the motor bracket may comprise any other suitable material, such as a stamped metallic material, while remaining within the spirit and scope of the present invention.

Accordingly, drive motor assembly 116 may be attached to motor bracket 118 via fasteners 130. Such an assembly may be made at the vehicle assembly plant or at another facility, whereby the motor and bracket construction may be shipped to the vehicle assembly plant as an assembled unit. Optionally, and desirably, the motor assembly comprises a common drive motor assembly that may be used for various window assemblies, and a particular motor bracket 118 is selected that attaches to the common drive motor assembly and that is adapted for mounting to the particular vehicle of that application of the rear slider window assembly.

The drive motor and bracket assembly may then be readily mounted to the drive portion of the slider mechanism without the use of any fasteners or tools. For example, the drive motor and bracket assembly may be snapped to the mounting plate 120 of drive portion 114a of slider mechanism 114. In the illustrated embodiment, the bosses 134 of plate portion 118b may be at least partially received in the passageways 121 (FIG. 9) of bosses 120a of mounting plate 120 to assist in aligning the mounting plate 120 and drive portion 114a of slider mechanism 114 with the motor bracket 118 and drive pinion or gear 132 of drive motor 116. As the plates 118b and 120 are moved toward one another and together, the drive pinion 132 is received in or engages spool 123 to couple the drive motor with the drive portion of the slider mechanism. The plates 118b and 120 are moved together such that tabs 136 of plate portion 118b are received in and through slots 120b of mounting plate 120, whereby the tabs snap into the slots and limit or substantially preclude separation of the plates 118b, 120. The vehicle mounting portion 118c of motor bracket 118 may then be secured to the vehicle at the appropriate location (or optionally, the vehicle mounting portion 118c may be secured to the vehicle prior to the drive portion of the drive mechanism being snapped to the motor bracket). After the components are snapped together (or optionally, before connecting the slider mechanism drive portion to the drive motor assembly), an operator may readily connect the vehicle wire harness or harnesses to the appropriate electrical connector or connectors 138 of the drive motor assembly to provide electrical power and control to the drive motor 11 6a of the rear slider window assembly.

The present invention thus provides a rear slider window assembly that has the drive motor assembly shipped as a separate detached component relative to the slider window module and slider mechanism. The slider mechanism may be readily attached to the drive motor assembly via a snapping connection or interlocking connection, and without the use of any separate fasteners, such as separate threaded fasteners, and without the use of a rotational drive tool, such as a screwdriver or powered screwdriver or the like. The present invention thus provides for such attachment/connection as a fastenerless or fastener-free process, which is advantageous to the processing and to the operator or operators at the vehicle assembly plant.

Although shown as having generally cylindrical guide elements or bosses extending from the motor bracket for engaging apertures of the mounting plate of the drive portion of the slider mechanism, it is envisioned that other shaped guide elements and bosses (such as, for example, conical shaped bosses or the like to ease alignment with the passageways of the receiving alignment elements) may be utilized without affecting the scope of the present invention. Also, the guide elements may extend from the mounting plate of the drive portion of the slider mechanism and may be guided and received into receiving portions or guide portions of the motor bracket while remaining within the spirit and scope of the present invention. Likewise, although shown as having tabs protruding from the motor bracket for engaging slots at the mounting plate of the slider drive portion, other shaped locking elements may be utilized, or the slider mechanism mounting plate may include tabs or other locking elements that engage slots or corresponding locking elements at the motor bracket, without affecting the scope of the present invention.

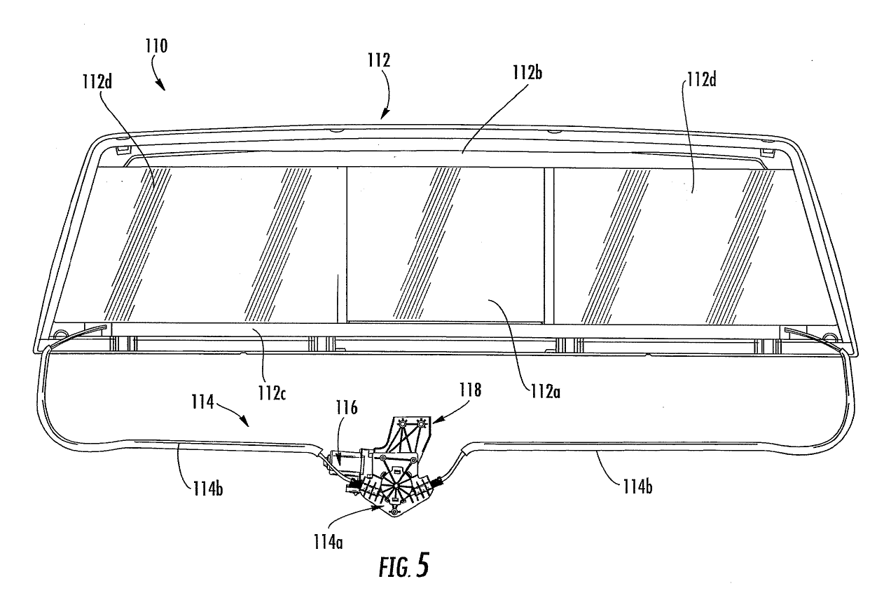

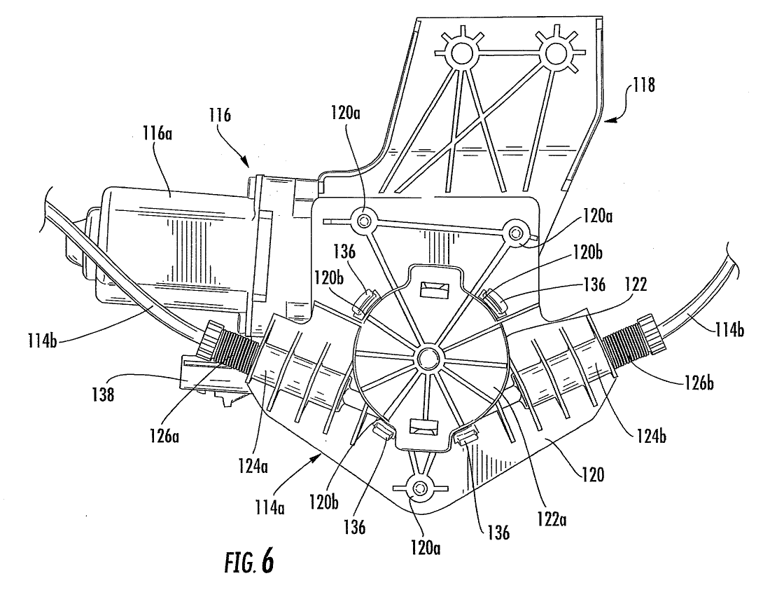

Accordingly, the drive portion 114a of the slider mechanism 114 of the rear slider window assembly 110 is attached to the motor 116 and motor bracket 118 (such as shown in FIGS. 5 and 6) at the vehicle assembly plant. Thus, the window module 112 and slider mechanism 114 may be shipped without the motor and bracket attached thereto, which substantially reduces the space taken up by the window module, such that more window modules may be shipped in a particular container to the vehicle assembly plant. At the vehicle assembly plant, an operator may install the window module to the vehicle (such as via adhering or bonding or fastening or otherwise attaching or mounting the window frame or panels to the vehicle sheet metal, and an operator may readily mount or attach the drive motor and bracket to the drive portion 114a of the slider mechanism 114 without the use of fasteners, thereby easing the assembly process and reducing the time involved during the assembly process, while also reducing the parts at the assembly plant and removing a required tool from the assembly plant. The operator at the vehicle assembly plant thus may readily attach the slider mechanism mounting plate and drive portion to the motor bracket and drive pinion via a snap together arrangement, whereby the drive pinion and spool, and the snaps or locking elements, are guided toward one another via the guide elements or bosses to ensure a locked together connection and proper aligned connection or coupling of the slider mechanism and drive motor assembly. The present invention thus provides an enhanced assembly process for installing a rear slider window assembly at a vehicle assembly plant, and may provide a plastic mounting system or arrangement that utilizes a common motor with different plastic mounting brackets depending on the particular application of the window assembly.

Further, the present invention allows the system to be detached, such as by unsnapping the detents or snaps or clips so that the slider mechanism may be readily detached from the drive motor assembly. For example, a service technician or even the owner of the vehicle may advantageously and readily detach the components by manipulating and unsnapping or disengaging the tabs or snaps or detents. Such a system thus may be advantageous for the layman who may want to work on his or her own vehicle and repair or replace various components.

Changes and modifications to the specifically described embodiments may be carried out without departing from the principles of the present invention, which is intended to be limited only by the scope of the appended claims, as interpreted according to the principles of patent law.

1. A rear slider window assembly for a vehicle, said rear slider window assembly comprising:
a window module having a movable window panel that is movable along at least one guide rail;
a drive mechanism that is operable to move said movable window panel;
a drive motor assembly that is selectively actuatable to rotatably drive said drive mechanism to move said movable window panel along said at least one guide rail; and
said drive motor assembly being connected to said drive mechanism via a snap connection and without any separate fasteners.

2. The rear slider window assembly of claim 1, wherein said drive motor assembly and said drive mechanism include guide elements for aligning and guiding the drive motor assembly and said drive mechanism as they are connected together.

3. The rear slider window assembly of claim 1, wherein one of said drive motor assembly and said drive mechanism includes at least one locking element that engages a locking element of the other of said drive motor assembly and said drive mechanism to substantially lock said drive motor assembly to said drive mechanism.

4. A method of installing a rear slider window assembly at a vehicle, said method comprising:
providing a window module to a vehicle assembly plant, said window module comprising a movable window panel that is movable along at least one guide rail, said window module comprising a slider drive mechanism for moving said movable window panel;
providing a drive motor assembly to the vehicle assembly plant, said drive motor assembly being selectively actuatable to rotatably drive said drive mechanism when connected thereto to move said movable window panel along said at least one guide rail, said drive motor assembly being provided to the vehicle assembly plant as a separate, detached component that is separate and detached from said slider drive mechanism; and
connecting said drive motor assembly to said drive mechanism at the vehicle assembly plant, wherein connecting said drive motor assembly to said drive mechanism comprises connecting said drive motor assembly to said drive mechanism via a snap connection and without any separate fasteners.

5. The method of claim 4 further comprising guiding and aligning said drive motor assembly relative to said drive mechanism via guide elements so that said drive motor assembly is substantially aligned with said drive mechanism prior to connecting said drive motor assembly to said drive mechanism via said snap connection.

6. The method of claim 4, wherein said drive motor assembly is fastened to a motor bracket for mounting said drive motor assembly to the vehicle, said motor bracket being connected to said drive mechanism via said snap connection.
